(19) United States
(12) Patent Application Publication
(10) Pub. No.: US 2026/0299329 A1
(43) Pub. Date: Oct. 1, 2026

(54) OPTICAL WAVEGUIDE DEVICE, AND OPTICAL MODULATION DEVICE AND OPTICAL TRANSMISSION APPARATUS USING SAME

(71) Applicant: SUMITOMO OSAKA CEMENT CO., LTD., Tokyo (JP)

(72) Inventors: Kosuke OKAHASHI, Tokyo (JP); Yu KATAOKA, Tokyo (JP); Shingo TAKANO, Tokyo (JP)

(73) Assignee: SUMITOMO OSAKA CEMENT CO., LTD., Tokyo (JP)

(21) Appl. No.: 18/879,634

(22) PCT Filed: Sep. 27, 2023
(86) PCT No.: PCT/JP2023/035243

§ 371 Date: Dec. 27, 2024

(51) Int. Cl. G02F 1/035; G02F 1/03

(52) U.S. Cl. CPC G02F 1/035; G02F 1/0327; G02F 2201/02; G02F 2201/122

(57) ABSTRACT

An object of the present invention is to provide an optical waveguide device that suppresses defective formation of a modulation electrode including a segment electrode and that achieves a high product yield.

There is provided an optical waveguide device including: a substrate on which an optical waveguide is formed; and a modulation electrode that is disposed on the substrate and that is used to apply an electric field to the optical waveguide to modulate a light wave propagating through the optical waveguide, in which the modulation electrode includes a plurality of segment electrodes SE that are disposed in proximity to the optical waveguide and along the optical waveguide, and a signal transmission section that is electrically connected to the segment electrodes SE and that transmits a modulation signal, and the segment electrode SE has a T-shape including a horizontal line L1 and a vertical line L2, and an end portion of the horizontal line L1 includes a corner portion (K1, K2) formed with a circular arc or two or more corners.

### TECHNICAL FIELD

The present invention relates to an optical waveguide device, and an optical modulation device and an optical transmission apparatus using the same, and more particularly, to an optical waveguide device including a substrate on which an optical waveguide is formed, and a modulation electrode that is disposed on the substrate and that is used to apply an electric field to the optical waveguide to modulate a light wave propagating through the optical waveguide.

### BACKGROUND ART

In the field of optical communication and in the field of optical measurement, optical waveguide devices in which an optical waveguide is formed on a substrate, such as an optical modulator, are widely used. In recent years, the optical modulator that is provided in a transmitter incorporated into an optical transmission and reception apparatus is required to miniaturize the optical waveguide device constituting the optical modulator in order to meet demands for size reduction and lower power consumption.

In addition, in order to achieve velocity matching and impedance matching between a light wave propagating through the optical waveguide and a microwave, which is a modulation signal propagating through a modulation electrode, as disclosed in Patent Literature Nos. 1 and 2, structures using segment electrodes for the modulation electrode have also been proposed to broaden the bandwidth of the optical modulator. FIG. 1 is an example of a modulation electrode using a segment electrode SE. The modulation electrode includes a plurality of segment electrodes SE that are disposed in proximity to the optical waveguide 10 and along an optical waveguide 10, and a signal transmission section SS that is electrically connected to the segment electrodes SE and that transmits the modulation signal.

In Patent Literature No. 1, the segment electrode is formed only on a ground electrode, and in Patent Literature No. 2, the segment electrode and an RF electrode, which is a signal transmission channel, are disposed with a dielectric layer therebetween.

In a high bandwidth-coherent driver modulator (HB-CDM) or the like, the optical waveguide device (chip) itself has been reduced in size, and the electrode width has become narrower and the electrode thickness has also been reduced as compared with an optical modulator in the related art.

Therefore, in a case where the electrode is thinned, resist cracks (cracks) are likely to occur at a location where stress in a resist pattern is biased during resist patterning for forming the pattern of the segment electrode. In a case where the resist cracks occur, defective electrode formation may result, leading to a significant reduction in product yield.

In the modulation electrode using the segment electrode SE in FIG. 1, an end portion of a horizontal line and an end portion of a vertical line of a “T-shape” constituting the segment electrode SE and a portion where the horizontal line and the vertical line intersect each other are at right angles. Such right-angled portions tend to concentrate internal stress, leading to the occurrence of resist cracks in the resist pattern.

### CITATION LIST

### Patent Literature

[Patent Literature No. 1] Japanese Patent No. 6075576
[Patent Literature No. 2] Japanese Laid-open Patent Publication No. 2016-194544

### SUMMARY OF INVENTION

### Technical Problem

An object to be achieved by the present invention is to provide an optical waveguide device that solves the above-mentioned problems, that suppresses defective formation of a modulation electrode including a segment electrode, and that achieves a high product yield. Additionally, the object is to provide an optical modulation device and an optical transmission apparatus using such an optical waveguide device.

### Solution to Problem

In order to achieve the object, an optical waveguide device, an optical modulation device, and an optical transmission apparatus of the present invention have the following technical features.
(1) There is provided an optical waveguide device including: a substrate on which an optical waveguide is formed; and a modulation electrode that is disposed on the substrate and that is used to apply an electric field to the optical waveguide to modulate a light wave propagating through the optical waveguide, in which the modulation electrode includes a plurality of segment electrodes that are disposed in proximity to the optical waveguide and along the optical waveguide, and a signal transmission section that is electrically connected to the segment electrodes and that transmits a modulation signal, and the segment electrode has a T-shape including a horizontal line L1 and a vertical line L2, and an end portion of the horizontal line L1 includes a corner portion formed with a circular arc or two or more corners.
(2) In the optical waveguide device according to (1), the end portion of the horizontal line L1 includes a corner portion K1 closer to the optical waveguide and a corner portion K2 farther from the optical waveguide, and the corner portion K1 and the corner portion K2 are set to have line-symmetrical shapes with respect to a centerline that is parallel to a longitudinal direction of the horizontal line L1.
(3) In the optical waveguide device according to (1), the end portion of the horizontal line L1 includes a corner portion K1 closer to the optical waveguide and a corner portion K2 farther from the optical waveguide, and in terms of a curvature formed by a circular arc or two or more corners at the corner portion K1 and the corner portion K2, the corner portion K2 is formed more gently than the curvature of corner portion K1.
(4) In the optical waveguide device according to (1), the circular arc has a curvature radius of 1 μm or greater.
(5) In the optical waveguide device according to (1), the segment electrode has a thickness of 3 μm or less, the horizontal line L1 has a width of 6 μm or less, and the vertical line L2 has a width of 5 μm or greater.
(6) In the optical waveguide device according to (5), the signal transmission section has a thickness equal to or greater than three times the thickness of the segment electrode, and the signal transmission section has a cross-section formed in a multi-stage shape, the cross-section being perpendicular to a transmission direction of the modulation signal.
(7) There is provided an optical modulation device including: the optical waveguide device according to any one of (1) to (6); a case that accommodates the optical waveguide device; and an optical fiber through which a light wave is input into the optical waveguide or output from the optical waveguide.
(8) In the optical modulation device according to (7), an electronic circuit that amplifies a modulation signal to be input to the modulation electrode of the optical waveguide device is further provided inside the case.
(9) There is provided an optical transmission apparatus including: the optical modulation device according to (7); and an electronic circuit that outputs a modulation signal for causing the optical modulation device to perform a modulation operation.

### Advantageous Effects of Invention

The present invention relates to an optical waveguide device including: a substrate on which an optical waveguide is formed; and a modulation electrode that is disposed on the substrate and that is used to apply an electric field to the optical waveguide to modulate a light wave propagating through the optical waveguide, in which in proximity to the optical waveguide and along the optical waveguide, and a signal transmission section that is electrically connected to the segment electrodes and that transmits a modulation signal, and the segment electrode has a T-shape including a horizontal line L1 and a vertical line L2, and an end portion of the horizontal line L1 includes a corner portion formed with a circular arc or two or more corners. Therefore, the corner portion has an internal angle of 90 degrees or greater, thereby making it possible to suppress the occurrence of resist cracks in a resist pattern during the formation of the segment electrode. As a result, it is also possible to increase the product yield of the optical waveguide device.

Additionally, it is also possible to provide an optical modulation device and an optical transmission apparatus using the optical waveguide device.

### BRIEF DESCRIPTION OF DRAWINGS

FIG. 1 is a diagram showing an example in which segment electrodes are provided on both a signal electrode and a ground electrode.

FIG. 2 is a plan view showing an example of an optical waveguide device of the present invention.

FIG. 3 is a diagram illustrating a shape of the segment electrode in the optical waveguide device of the present invention.

FIG. 4 is a diagram illustrating dimensions of the Segment electrode.

FIGS. 5A to 5E are diagrams illustrating other shapes of the segment electrode.

FIG. 6 is a diagram illustrating a state in which the segment electrode and a signal transmission section are combined.

FIG. 7 is a diagram illustrating the dimensions of the segment electrode and a disposition relationship between the segment electrode and the signal transmission section.

FIG. 8 is a cross-sectional view taken along an alternate long and short dash line D in FIG. 6.

FIG. 9 is a cross-sectional view taken along an alternate long and short dash line E in FIG. 6.

FIG. 10 is a diagram illustrating an application example of FIG. 9.

FIG. 11 is a diagram illustrating an example applied to a Z-cut substrate (Example 1).

FIG. 12 is a diagram illustrating an example applied to the Z-cut substrate (Example 2).

FIG. 13 is a diagram illustrating an optical transmission apparatus of the present invention.

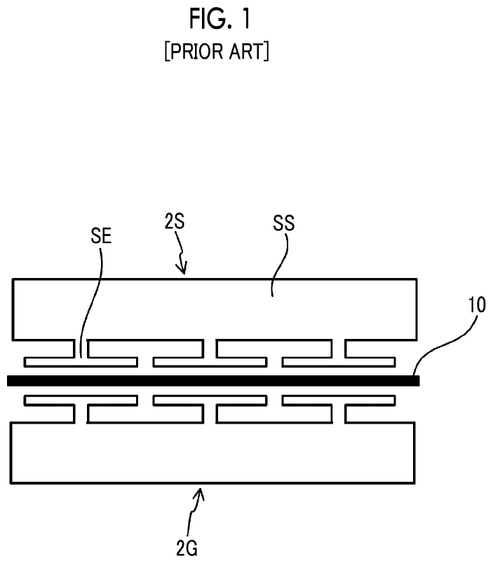

### DESCRIPTION OF EMBODIMENTS

The present invention will be described below in detail using preferred examples.

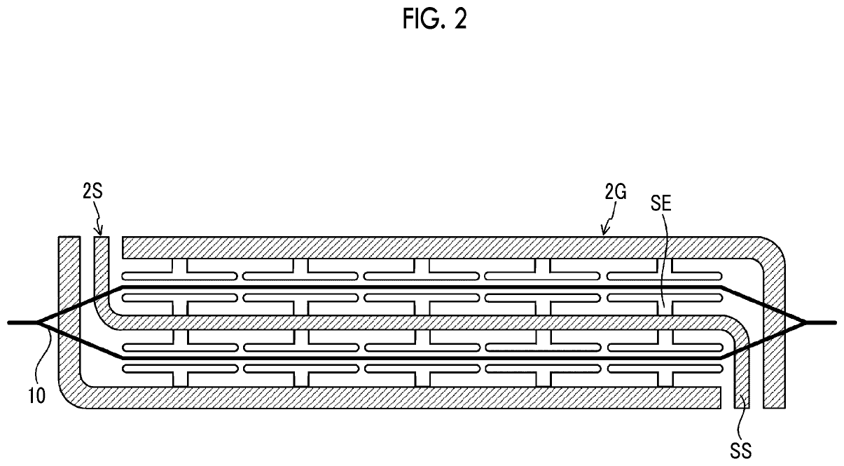

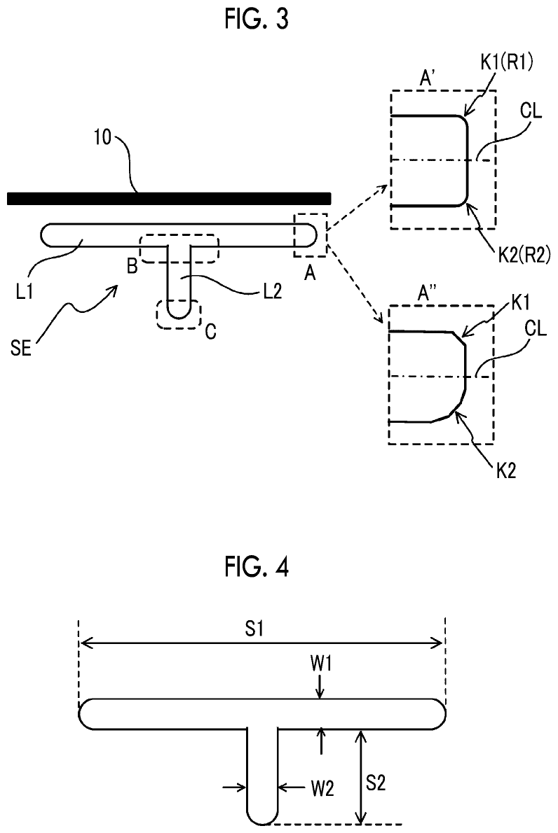

As shown in FIGS. 2 and 3, the present invention relates to an optical waveguide device including: a substrate on which an optical waveguide 10 is formed; and a modulation electrode (2S, 2G) that is disposed on the substrate and that is used to apply an electric field to the optical waveguide 10 to modulate a light wave propagating through the optical waveguide, in which the modulation electrode includes a plurality of segment electrodes SE that are disposed in proximity to the optical waveguide and along the optical waveguide, and a signal transmission section SS that is electrically connected to the segment electrodes SE and that transmits a modulation signal, and the segment electrode SE has a T-shape including a horizontal line L1 and a vertical line L2, and an end portion of the horizontal line L1 includes a corner portion (K1, K2) formed with a circular arc or two or more corners.

As a substrate used for the optical waveguide device, specifically, as a substrate having an electro-optic effect, a substrate of lithium niobate (LN), lithium tantalate (LT), lead lanthanum zirconate titanate (PLZT), or the like, or a base material obtained by doping these substrate materials with MgO or the like can be used. Additionally, a film of a material such as LN can also be formed on a support substrate of Si, glass, sapphire, or the like directly or with an interlayer therebetween, through vapor-phase growth. Further, a substrate obtained by bonding a substrate having an electro-optic effect to another substrate and then processing an electro-optical substrate into a thin film can also be used. Furthermore, a semiconductor substrate, a substrate of an organic material such as an EO polymer, and a quartz substrate used in PLC can also be used. A different semiconductor film may be grown on the semiconductor substrate. Further, since the substrate (waveguide layer) on which the optical waveguide is formed is significantly thin, for example, 1 μm or less, a support substrate having a dielectric constant lower than the dielectric constant of the waveguide layer is suitably used.

The optical waveguide can be obtained by locally forming a portion having a high refractive index using a method of thermally diffusing Ti or the like into the LN substrate, a proton exchange method, or the like as a method for forming the optical waveguide. In the present invention, a rib type optical waveguide in which a portion corresponding to the optical waveguide is formed as a protrusion on the substrate can be obtained by etching a surface of the substrate excluding the optical waveguide or by forming grooves on both sides of the optical waveguide. The optical waveguide device of the present invention is particularly effective for a step-index (SI) type optical waveguide in which a discontinuous point where a refractive index discontinues occurs, such as a rib type optical waveguide, rather than for a graded-index (GI) type optical waveguide, such as a diffused waveguide.

The LN substrate used in the present invention is not limited to X-cut or Z-cut; however, in the following description, an example will be described mainly focusing on an optical waveguide device (chip) in which an X-cut LN substrate is used as a substrate and a rib type optical waveguide having, for example, a height of 1 μm or less is formed.

The main features of the optical waveguide device of the present invention are as follows: (1) as shown in FIG. 2, the modulation electrode (2S, 2G) includes the plurality of segment electrodes SE that are disposed in proximity to the optical waveguide and along the optical waveguide, and the signal transmission section SS that is electrically connected to the segment electrodes and that transmits the modulation signal; and (2) as shown in FIG. 3, the segment electrode has a T-shape including the horizontal line L1 and the vertical line L2, and the end portion of the horizontal line L1 includes the corner portion (K1, K2) formed with a circular arc or two or more corners.

In the optical waveguide device of the present invention, the segment electrode SE and the signal transmission section SS of the modulation electrode are formed as separate electrode portions through different manufacturing processes.

Since the segment electrode SE has a thickness of 3 μm or less and preferably 1 μm or less, the segment electrode SE is formed by plating, vapor deposition, or sputtering. In addition, since the signal transmission section SS has a thickness equal to or greater than three times the thickness of the segment electrode, the signal transmission section SS is formed by plating. The thicker the film thickness of the resist pattern is, the more likely resist cracks are to occur. Further, the thinner the thickness of the segment electrode SE is, the lower the high-frequency loss is, which can reduce the deterioration of high-frequency characteristics.

In the formation of the segment electrode SE, in regions A to C indicated by dashed frames in FIG. 3 in which the corner portions of the segment electrode are formed, the corner portions are each formed with a circular arc or two or more corners (the polygon has an internal angle of 90 degrees or greater) to prevent the occurrence of resist cracks in the resist pattern. Particularly, in the horizontal line L1 that plays a role in forming an electric field to be applied to the optical waveguide, the end portion of the horizontal line L1 includes the corner portion (K1, K2) formed with a circular arc (refer to a dashed frame A′) or two or more corners (refer to a dashed frame A″) to prevent the occurrence of resist cracks.

The enlarged view of the region A of the dashed frame is the dashed frame A′ or the dashed frame A″.

In the dashed frame A′, the corner portion K1 is formed with a circular arc having a curvature radius R1. In addition, the corner portion K2 is formed with a circular arc having a curvature radius R2. In order to suppress the occurrence of resist cracks, the curvature radius R1 (R2) of the circular arc is preferably 1 μm or greater.

Meanwhile, in the dashed frame A″, the corner portion K1 is formed with two corners. Additionally, the corner portion K2 is formed with four corners. The internal angle of each corner is set to be 90 degrees or greater and more preferably 120 degrees or greater, which suppresses the occurrence of resist cracks as compared with a case where the corner portion in the related art is at a right angle.

In a case where one corner portion is formed with a plurality of corners, it is preferable to increase the number of corners and to increase the internal angle of each corner. However, in a case where the gap between the first corner and the last corner is too close, the effect of increasing the internal angle is diminished. Therefore, for example, it is preferable to set the gap between the first corner and the last corner to 0.2 μm or greater.

Regarding the shapes of the corner portion K1 and the corner portion K2, the corner portion K1 and the corner portion K2 can be formed to have line-symmetrical shapes with respect to a centerline CL (refer to the dashed frame A′ in FIG. 3) that is parallel to the longitudinal direction of the horizontal line L1.

Specifically, the curvature radii R1 and R2 of the corner portions formed by the circular arcs are set to the same size. Consequently, since the end portion within the dashed frame A′ in FIG. 3 has a vertically symmetrical shape, the internal stress of the resist pattern disposed in the vicinity of the corner portions of the end portion of the horizontal line L1 can be evenly distributed between the two corner portions (K1, K2). As a result, not only the occurrence of resist cracks can be suppressed, but also the distortion of the resist pattern can be suppressed, thereby making it possible to suppress the deformation of the segment electrode.

As another example, by forming the corner portion K1 and the corner portion K2 into line-symmetrical shapes with respect to the centerline CL even in a case where the shapes of the corner portion K1 and the corner portion K2 are formed with two or more corners, the internal stress of the resist pattern disposed in the vicinity of the corner portions can be evenly distributed between the two corner portions (K1, K2), and the same effect as that of the corner portion formed with the above-mentioned circular arc can be obtained.

In addition, the “curvature” formed by the circular arc or two or more corners at the corner portion K1 and the corner portion K2 can be formed to be gentler at the corner portion K2 than at the corner portion K1.

Here, the “curvature” does not refer solely to a shape formed by a curve, but includes a shape formed by polygonal lines with a plurality of corners.

Specifically, by setting the curvature radii of the corner portions to R1<R2, it is possible to allow for stress relaxation and improvement of high-frequency characteristics while maintaining a constant distance between the optical waveguide and the electrode.

By setting the curvature radius of R1 to 5 μm or less, the gap between the electrodes can be increased, thereby mitigating the influence of the decrease in the modulation efficiency. By setting the curvature radius of R2 to 3 μm or greater, the occurrence of resist cracks can be further suppressed.

Further, the curvature radii of the corner portions can be set to R1>R2 as necessary.

Additionally, in a case where the corner portion is formed with two or more corners, the sum of the internal angles of all the corners constituting the corner portion, or the sum of the lengths of straight lines connecting the plurality of corners, is set such that the corner portion K2 is greater than the corner portion K1. As a result, it is possible to maintain a longer and constant distance between the optical waveguide and the segment electrode, which contributes not only to stress relaxation but also to improvement of high-frequency characteristics.

Next, the dimensions of the segment electrode will be described with reference to FIG. 4.

Regarding the width of the segment electrode, a width W1 of the horizontal line L1 is set to 6 μm or less and preferably 4 μm or less. Regarding the horizontal line L1, basically a thinner width is advantageous for high-frequency characteristics. This is because, in the signal electrode, a wider horizontal line L1 causes the modulation signal to perceive the segment electrode as unevenness protruding to a side surface of the signal electrode, resulting in the deterioration of high-frequency characteristics. For this reason, it is preferable for the horizontal line L1 to have a narrower width and a thinner thickness.

In addition, the width W2 of the vertical line L2 is set to 5 μm or greater and preferably 10 μm or greater. In a case where the vertical line L2 does not have a certain thickness or greater, the electrical connection between the Segment electrode SE and the signal transmission section SS is unstable.

Regarding the length of the segment electrode, a length S1 of the horizontal line L1 needs to be sufficiently short from a high-frequency perspective due to the frequencies handled in the optical modulator or the like. Specifically, the length need only be approximately one-fourth to one-eighth of the wavelength of a microwave, which is the modulation signal, and may be even shorter than that. For example, in a case of operating at a frequency of 100 GHz or less, the length S1 of the horizontal line L1 is desirably 400 μm or less.

Regarding a length S2 of the vertical line L2, similar to the width of the vertical line L2, basically, a longer length S2 increases the overlapping area between the segment electrode and the signal transmission section, resulting in a better electrical connection between the segment electrode and the signal transmission section. However, in a case where the length S2 is too long, the gap between branched waveguides of a Mach-Zehnder type optical waveguide also increases, and the size of the optical waveguide device (chip) itself also increases. Therefore, the length S2 is set to 100 μm or less.

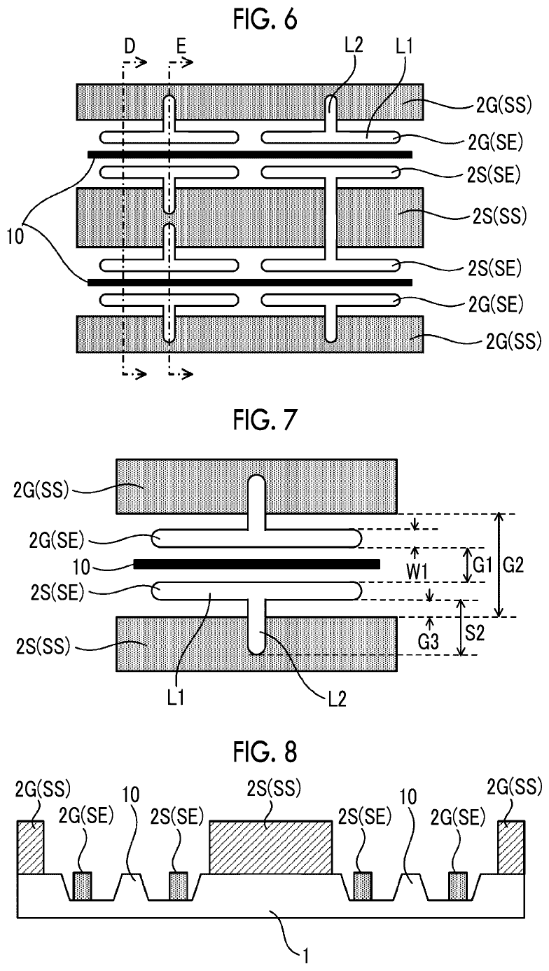

Additionally, as shown in the signal transmission section SS of the signal electrode 2S in FIG. 6, in a case where the segment electrodes SE are disposed on both sides of the signal transmission section of the signal electrode or the ground electrode, the vertical line L2 can also be configured such that the vertical lines L2 of two segment electrodes are connected in an “H-shape” as in the segment electrode at the center right in FIG. 6.

Regarding the curvature radius (R1, R2) of the corner portion of the segment electrode, it is preferable to set the curvature radius to 1 μm or greater in order to avoid the resist cracks as mentioned above. However, since the size of the curvature radius also affects the shape of the end portion of the horizontal line L1, the curvature radius is set to be equal to or less than the width W1 of the horizontal line L1, preferably less than half of the width W1, and more preferably equal to or less than one-third of the width W1.

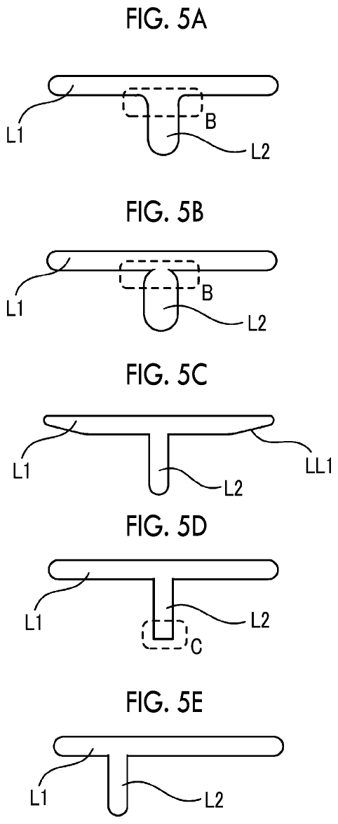

FIGS. 5A to 5E illustrate various shapes of the segment electrode.

Not only the end portion of the horizontal line L1 of the segment electrode but also a portion (the region B of the dashed frame) where the horizontal line L1 and the vertical line L2 intersect each other can be connected by a circular arc as shown in FIG. 5A. As a result, the occurrence of resist cracks at the intersection portion between the horizontal line L1 and the vertical line L2 can be suppressed.

FIG. 5B shows a shape in which a circular arc is formed in the vertical line L2 and is connected to the straight horizontal line L1, and the intersection portion has a constricted shape, as shown in the region B. In the constricted portion, the width of the resist film becomes narrower, resulting in weaker stress generation and making it less likely for resist cracks to occur.

FIG. 5C shows that tapered shapes, in which the width gradually narrows, are formed at respective end portions of the horizontal line L1. Since a side (side portion) of the horizontal line L1 on an optical waveguide side needs to maintain a constant distance from the optical waveguide, the shape of a side (side portion) away from the optical waveguide is changed. With such a shape, it is also possible to maintain a constant distance between the optical waveguide and the electrode, which is expected to have the effect of further improving high-frequency characteristics.

FIG. 5D shows that the end portion of the vertical line L2 of the segment electrode is formed at a right angle as in the related art. As a result, the possibility of resist cracks occurring in the resist pattern at the end portion of the vertical line L2 increases, but the vicinity of the end portion is covered with the signal transmission section SS. Therefore, the influence of the resist cracks is small.

FIG. 5E shows a shape of the segment electrode that is not a left-right symmetrical T-shape but rather a T-shape biased to one side. Assuming that an advancing direction of the propagating light of the optical waveguide is a right direction in the drawing, when the modulation signal that has entered from the vertical line L2 propagates to the right side of the horizontal line L1, the modulation signal propagates in the same direction (forward modulation) as the propagating light, resulting in high modulation efficiency. In addition, when the modulation signal propagates to the left side of the horizontal line L1, the modulation signal propagates in an opposite direction to the propagating light (reverse modulation). Therefore, by having a configuration as shown in FIG. 5E, it is possible to extend the section of forward modulation and shorten the section of reverse modulation. In some cases, it is also possible to dispose the horizontal line L1 only in the direction of forward modulation as in an L-shape.

In this way, the shape of the segment electrode can be variously modified according to the characteristics expected for the optical waveguide device.

FIG. 6 is a diagram illustrating a state in which the signal transmission section SS is disposed to overlap the segment electrode SE. In order to make the shape of the segment electrode easier to understand, a portion overlapping the signal transmission section is also shown on the surface.

In addition, FIG. 7 is an extracted diagram of a pair of segment electrodes interposing the optical waveguide 10 from FIG. 6 and a diagram illustrating the dimensions of the segment electrode and the disposition relationship between the segment electrode and the signal transmission section. The dimensions of the segment electrode are the Same as those in FIG. 4.

The left side of FIG. 6 shows a normal segment electrode (SE), and individual segment electrodes are disposed separately. On the other hand, as mentioned above, the segment electrode SE on the right side of FIG. 6 employs an “H-shape” that connects the vertical lines L2 of two segment electrodes located on both sides of the signal transmission section. Naturally, the “H-shape” has a larger area of the overlapping portion between the vertical line L2 and the signal transmission section SS, thereby allowing for a more reliable electrical connection.

An electrode gap G1 between the segment electrode SE of the signal electrode 2S and the segment electrode SE of the ground electrode 2G shown in FIG. 7 is preferably disposed in proximity to the optical waveguide 10 in a range in which the light wave propagating through the optical waveguide 10 is not absorbed. For example, the gap G1 is set to be equal to or greater than twice the mode field diameter of the light wave propagating through the optical waveguide 10 and is 3 μm or greater.

In a case where a gap G3 between the horizontal line L1 of the segment electrode SE and the signal transmission section SS is too small, the electric field formed by the signal transmission section SS directly affects the optical waveguide 10. Therefore, although the gap G3 also depends on the size of the width W1 of the horizontal line L1 of the segment electrode SE, it is preferable for the gap G3 to be set to 1 μm or greater. Naturally, it is evident that the gap G3 is smaller than the length S2 of the vertical line L2 of the segment electrode SE (G3<S2). Conversely, the minimum value of the length S2 is set to a value obtained by adding the alignment accuracy between the segment electrode and the signal transmission section to the gap G3, with an additional margin.

A gap G2 between two signal transmission sections (2S (SS) and 2G (SS)) in FIG. 7 is 10 μm or greater, but is preferably set to 100 μm or less in order not to increase the size of the optical waveguide device (chip).

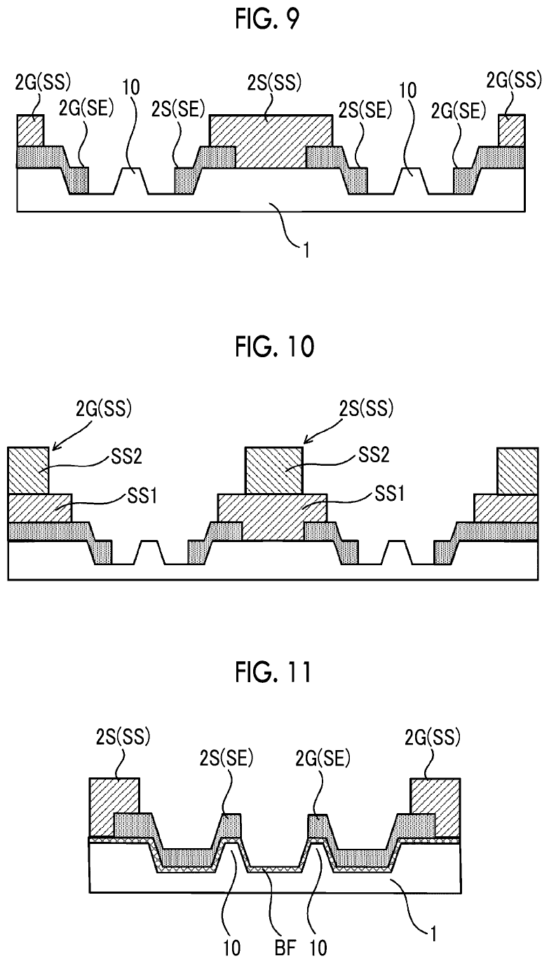

FIG. 8 is a cross-sectional view taken along an alternate long and short dash line D in FIG. 6, and FIG. 9 is a cross-sectional view taken along an alternate long and short dash line E in FIG. 6. As shown in FIGS. 8 and 9, the optical waveguide 10 is a rib type optical waveguide and is formed on a substrate 1. A protruding portion of the substrate 1 located beneath the segment electrode SE or the signal transmission section SS can be removed by etching or the like, similar to the periphery of the rib type optical waveguide, but may be left in order to ensure the mechanical strength of the substrate 1. In addition, in a case where the substrate 1 is used by being bonded to the support substrate (not shown), it is also possible to completely remove an unnecessary portion of the substrate 1.

FIG. 10 is an application example of FIG. 9, and the signal transmission section SS is formed with multiple electrode layers (SS1, SS2). The modulation electrode has a cross-section formed in a multi-stage shape (stepped shape), which is perpendicular to the transmission direction of the modulation signal. This allows for various modifications to the height and the gap between the signal electrode and the ground electrode in the signal transmission section SS, making it advantageous for impedance adjustment.

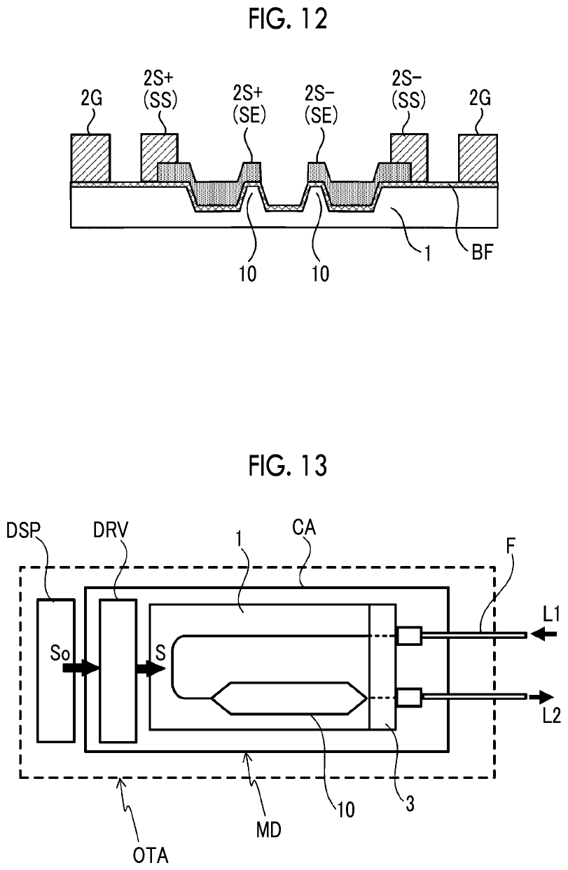

In the above description, the X-cut LN substrate has been mainly described, but it goes without saying that the technique relating to the optical waveguide device of the present invention can also be applied to a Z-cut LN substrate and the like. FIGS. 11 and 12 illustrate the disposition of the electrode applied to the Z-cut LN substrate and show cross-sectional views passing through the vertical line L2 of the segment electrode SE as in FIG. 9.

FIG. 11 shows an example in which an electric field is applied to two optical waveguides 10 using one signal electrode 2S and one ground electrode 2G.

Additionally, FIG. 12 is a diagram showing an example in a case where the electrical signals applied to the electrodes are G, S+, S−, and G (G is a ground potential, and S+ and S− are differential signals of opposite phases to each other). In the drawings, the electrical signal S+ is shown as 2S+, and the electrical signal S− is shown as 2S−.

The reference numeral BF indicates a buffer layer.

Next, an example of applying the optical waveguide device of the present invention to an optical modulation device and an optical transmission apparatus will be described. Hereinafter, the optical modulation device using the optical waveguide device mentioned above will be described, but the present invention is not limited thereto and can also be applied to an optical phase modulator, an optical modulator having a polarization combining function, an optical waveguide device in which a larger number of Mach-Zehnder type optical waveguides are integrated, a device bonded to an optical waveguide device made of other materials such as silicon, a device for sensor applications, and the like. Further, it goes without saying that the present invention is applicable to HB-CDM.

As shown in FIG. 13, the optical waveguide device includes the optical waveguide 10 formed on the substrate 1 and the modulation electrode (not shown) that modulates the light wave propagating through the optical waveguide 10 and is accommodated in a case CA. Moreover, an optical modulation device MD can be configured by providing optical fibers (F) through which the light waves are input to the optical waveguide and output from the optical waveguide. In FIG. 13, the optical fiber F is introduced into the case through a through-hole penetrating a side wall of the case and is directly bonded to the optical waveguide device (chip). The present invention is not limited thereto, and the optical fiber may be optically coupled to the optical waveguide 10 in the optical waveguide device by using an optical block provided with an optical lens, a lens barrel, or the like. Further, a reinforcing member 3 can also be disposed to overlap along an end surface of the substrate 1 in order to ensure stable bonding to the optical fiber or the optical block.

An optical transmission apparatus OTA can be configured by connecting, to the optical modulation device MD, an electronic circuit (digital signal processor DSP) that outputs a modulation signal So for causing the optical modulation device MD to perform a modulation operation. It is necessary to amplify the modulation signal So output from the digital signal processor DSP in order to obtain a modulation signal S applied to the optical waveguide device. Therefore, in FIG. 13, the modulation signal is amplified using a driver circuit DRV. The driver circuit DRV and the digital signal processor DSP can be disposed outside the case CA or can also be disposed inside the case CA. Particularly, by disposing the driver circuit DRV inside the case, it is possible to further reduce the propagation loss of the modulation signal from the driver circuit.

### INDUSTRIAL APPLICABILITY

As described above, according to the present invention, it is possible to provide an optical waveguide device that suppresses defective formation of the modulation electrode including the segment electrode and that achieves a high product yield. Additionally, it is possible to provide an optical modulation device and an optical transmission apparatus using such an optical waveguide device.

### REFERENCE SIGNS LIST

1: Substrate (waveguide layer)
3: Reinforcing member
10: Rib type optical waveguide
2G: Ground electrode
2S: Signal electrode
SE: Segment electrode
SS: Signal transmission section
L1: Horizontal line
L2: Vertical line
K1, K2: Corner portion
R1, R2: Curvature radius

1. An optical waveguide device comprising:
a substrate on which an optical waveguide is formed; and
a modulation electrode that is disposed on the substrate and that is used to apply an electric field to the optical waveguide to modulate a light wave propagating through the optical waveguide,
wherein the modulation electrode includes a plurality of segment electrodes that are disposed in proximity to the optical waveguide and along the optical waveguide, and a signal transmission section that is electrically connected to the segment electrodes and that transmits a modulation signal, and
the segment electrode has a T-shape including a horizontal line L1 and a vertical line L2, and an end portion of the horizontal line L1 includes a corner portion formed with a circular arc or two or more corners.

2. The optical waveguide device according to claim 1,
wherein the end portion of the horizontal line L1 includes a corner portion K1 closer to the optical waveguide and a corner portion K2 farther from the optical waveguide, and
the corner portion K1 and the corner portion K2 are set to have line-symmetrical shapes with respect to a centerline that is parallel to a longitudinal direction of the horizontal line L1.

3. The optical waveguide device according to claim 1,
wherein the end portion of the horizontal line L1 includes a corner portion K1 closer to the optical waveguide and a corner portion K2 farther from the optical waveguide, and
in terms of a curvature formed by a circular arc or two or more corners at the corner portion K1 and the corner portion K2, the curvature of the corner portion K2 is formed more gently than at the curvature of the corner portion K1.

4. The optical waveguide device according to claim 1,
wherein the circular arc has a curvature radius of 1 μm or greater.

5. The optical waveguide device according to claim 1,
wherein the segment electrode has a thickness of 3 μm or less,
the horizontal line L1 has a width of 6 μm or less, and
the vertical line L2 has a width of 5 μm or greater.

6. The optical waveguide device according to claim 5,
wherein the signal transmission section has a thickness equal to or greater than three times the thickness of the segment electrode, and
the signal transmission section has a cross-section formed in a multi-stage shape, the cross-section being perpendicular to a transmission direction of the modulation signal.

7. An optical modulation device comprising:
the optical waveguide device according to claim 1;
a case that accommodates the optical waveguide device; and
an optical fiber through which a light wave is input into the optical waveguide or output from the optical waveguide.

8. The optical modulation device according to claim 7, further comprising:
an electronic circuit that amplifies a modulation signal to be input to the modulation electrode of the optical waveguide device and that is provided inside the case.

9. An optical transmission apparatus comprising:
the optical modulation device according to claim 7; and
an electronic circuit that outputs a modulation signal for causing the optical modulation device to perform a modulation operation.
